(19) United States
(12) Patent Application Publication
(10) Pub. No.: US 2026/0032538 A1
(43) Pub. Date: Jan. 29, 2026

(54) ENABLING LAYER 1 AND LAYER 2 MOBILITY

(71) Applicant: InterDigital Patent Holdings, Inc., Wilmington, DE (US)

(72) Inventors: Oumer Teyeb, Montreal (CA); Brian Martin, Farnham (GB); Paul Marinier, Brossard (CA); Martino Freda, Laval (CA); Keiichi Kubota, Setagaya-Ku (JP)

(73) Assignee: InterDigital Patent Holdings, Inc., Wilmington, DE (US)

(21) Appl. No.: 19/099,993

(22) PCT Filed: Aug. 4, 2023
(86) PCT No.: PCT/US2023/071656

§ 371 Date: Jan. 30, 2025

Related U.S. Application Data
(60) Provisional application No. 63/395,215, filed on Aug. 4, 2022.
(60) Provisional application No. 63/410,909, filed on Sep. 28, 2022.

(51) Int. Cl. H04W 36/04; H04W 76/20; H04W 80/02

(52) U.S. Cl. CPC H04W 36/04; H04W 76/20; H04W 80/02

(57) ABSTRACT

A wireless transmit/receive unit (WTRU) may perform L1/L2 switching of primary cells. In an approach, the WTRU configured with configuration information that is common to a multitude of candidate cells and separate configuration information that is specific to each candidate cell, may receive an LTM indication to handover (HO) to a particular candidate cell. Upon receiving the LTM indication to HO to the particular candidate cell, the WTRU may keep the common configuration information, release the separate configuration information specific to the serving cell and/or apply the separate configuration information specific to the target candidate cell.

### CROSS REFERENCE TO RELATED APPLICATIONS

This application claims the benefit of U.S. Provisional Application Patent Application No. 63/410,909, filed Sep. 28, 2022, and U.S. Provisional Application Patent Application No. 63/395,215, filed Aug. 4, 2022. U.S. Provisional Application Nos. 63/410,909 and 63/395,215 are incorporated herein by reference in their entirety.

### BACKGROUND

The present disclosure relates generally to a device and method for mobility mechanisms. More specifically, the present techniques relate to enabling Layer 1 and Layer 2 (L1/L2) mobility.

Wireless communication systems have been expanded and diversified in order to provide various types of communication services such as voice or data service. Overall, a wireless communication system is a multiple access system capable of sharing available system resources (bandwidth, transmit power or the like) in order to support communication with multiple users. Examples of the multiple access system include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and the like.

### BRIEF SUMMARY

A wireless transmit/receive unit (WTRU) may perform L1/L2 switching of primary cells via L1/L2 triggered mobility (LTM). The LTM may have low latency during handover (HO), where the WTRU may perform the HO just based on a L1/L2 indication (e.g., MAC CE), where a secondary cell or even a non-serving cell from the candidate LTM set may be promoted to become the new PCell. As such, it may be necessary for the WTRU to have a proper pre-configuration of all possible target PCells. It may also be necessary for the WTRU to perform subsequent switching from one target PCell to another without requiring RRC reconfiguration.

The WTRU configured with a configuration that is common to a multitude of candidate cells and configurations that are specific to each candidate cell, may receive an LTM indication to HO to a particular candidate cell. Upon receiving the LTM indication to HO to the particular candidate cell, the WTRU may keep the common configuration, release the current cell specific configuration and/or apply the configuration specific to the target candidate cell.

The WTRU may receive configuration information related to LTM. The configuration information related to LTM may include a candidate cell group configuration. The candidate cell group configuration may include common configuration information for a serving cell and at least one candidate cell. The configuration information may also include separate configuration information specific to the serving cell and each candidate cell of the at least one candidate cell. The WTRU may perform communications with the serving cell based on the common configuration information and the information specific to the serving cell. The WTRU may receive an LTM command indicating handover (HO) to a candidate cell of the at least one candidate cell. The WTRU may release the information specific to the serving cell, while the WTRU may maintain the common information. Without performing a reconfiguration of the configuration information related to LTM, the WTRU may perform a handover to the candidate cell as a serving cell using the common configuration information and the information specific to the indicated candidate cell of the at least one candidate cell. The WTRU may then send a HO complete message to the network.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a sequence flow diagram that illustrates an example of a handover procedure.

FIG. 3 is a diagram that illustrates an example of an excerpt of information elements related to RRC reconfiguration.

FIGS. 4A-4C are diagrams that illustrate examples of an excerpt of RRC reconfiguration related information elements (IEs).

FIG. 5 is a diagram that illustrates an example of a Master Cell Group (MCG) and a Secondary Cell Group (SCG).

FIG. 6 is a diagram illustrating an example of L1/L2 inter-cell mobility operation.

FIG. 7 is a diagram that illustrates an example ASN.1 code for capturing an example L1/L2 mobility signaling.

FIG. 8 is a diagram that illustrates an example of a WTRU storing a configuration until it receives a L1/L2 message.

FIG. 9 is a diagram that illustrates an example of a WTRU storing a configuration until it receives a L1/L2 message.

FIG. 10 is a diagram illustrating an example ASN. 1 structure.

FIG. 11 is a flow chart illustrating a method for the WTRU to perform L1/L2 switching of primary cells (PCells) in an optimal way that may not require RRC reconfiguration for subsequent PCell change.

### DETAILED DESCRIPTION OF THE INVENTION

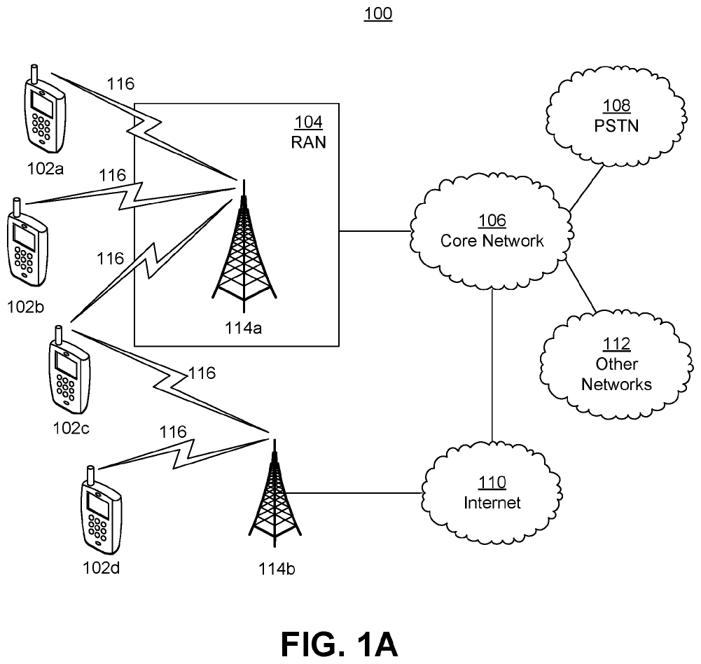

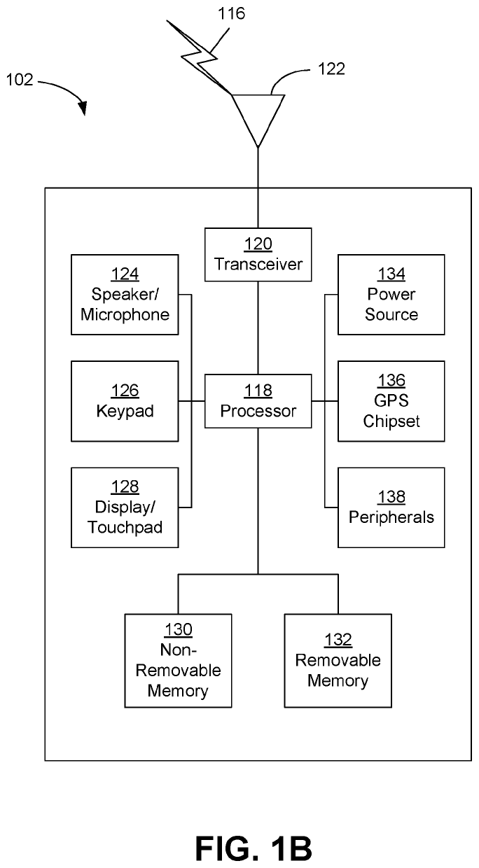

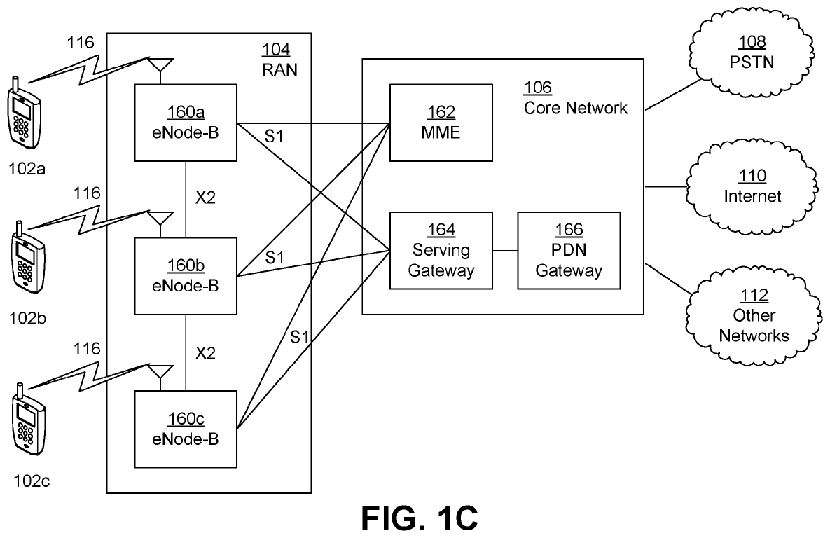

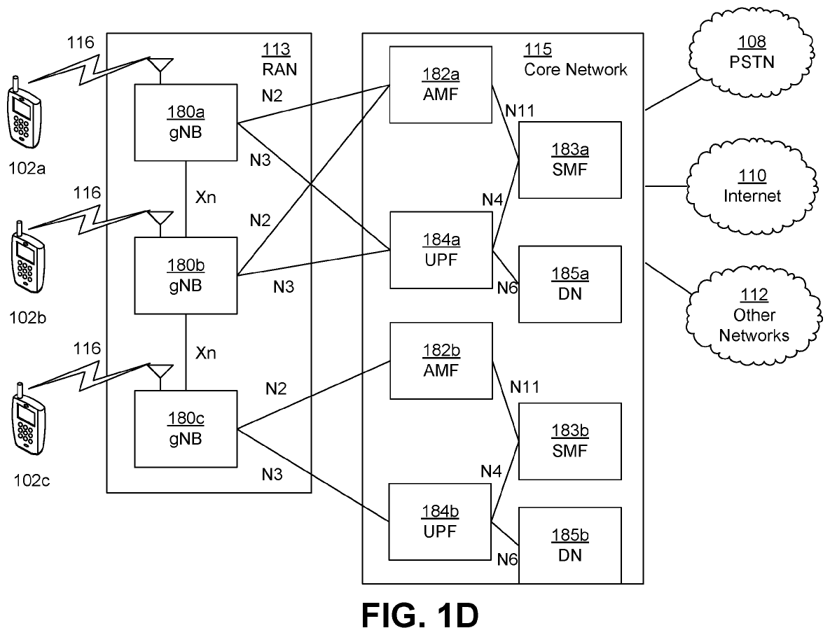

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Methods and apparatus are described herein that may implement carrier aggregation (CA). CA may enable transmission or reception simultaneously on multiple component carriers, while other methods and apparatus that are incapable of CA may access one of the component carriers. Each node (e.g., Node B, eNB, gNB, etc.) may service multiple cells. The cells may be collectively referred to as serving cells. The serving cells served by a node may be referred to as a cell group. The serving cells in a cell group may be divided into a primary cell (PCell) and one or more secondary cells (SCells). In an example, the PCell may be operating on the primary frequency, in which the WTRU may perform an initial connection establishment procedure. After the initial connection to the PCell, one or more SCells may be configured and/or added. The SCells can be activated or deceived to meet the variations in demand in the communication with the network (e.g., UL/DL throughput required by the WTRU, available network resources, etc.).

During dual connectivity (DC), a WTRU may be connected to multiple nodes. For example, the WTRU may be connected to a master node and one or more secondary nodes. Each of the master node and the secondary node may serve multiple cells. The master node may serve a cell group that may be referred to as a master cell group (MCG). The secondary node may serve a cell group that may be referred to as a secondary cell group (SCG). The primary cell for the master cell group may be referred to as the PCell, while (e.g., in case DC is configured), and the primary cell for the secondary cell group may be referred to as a Primary Secondary Cell (PSCell).

The term special cell (SpCell) may refer to either the PCell of the MCG or the PSCell of the SCG. There is one medium access control (MAC) entity associated to the MCG and another MAC entity associated with the SCG.

In an embodiment, a WTRU may receive a Radio Resource Control (RRC) reconfiguration that may include an SpCell configuration which may be associated with each SCell or SCell configuration associated with each SpCell. The WTRU may perform one or more of the following actions. In an example, upon the reception of a L1/L2 mobility set indication that promotes an SCell (e.g., cell b) to become the SpCell (e.g., where current SpCell may be cell a), the WTRU may release the current SpCell configuration (e.g., where current SpCell is associated with cell a). In an example, upon the reception of a L1/L2 mobility set indication that promotes an SCell (e.g., cell b) to become the SpCell (e.g., where current SpCell may be cell a), the WTRU may release the current SCell configuration (e.g., where current SCell is associated with cell b). In an example, upon the reception of a L1/L2 mobility set indication that promotes an SCell (e.g., cell b) to become the SpCell (e.g., where current SpCell may be cell a), the WTRU may apply the SpCell configuration associated with another cell (e.g., cell b). In an example, upon the reception of a L1/L2 mobility set indication that promotes an SCell (e.g., cell b) to become the SpCell (e.g., where current SpCell may be cell a), the WTRU may apply the SCell configuration associated with another cell (e.g., cell a). In an example, upon the reception of a L1/L2 mobility set indication that promotes an SCell (e.g., cell b) to become the SpCell (e.g., where current SpCell may be cell a), the WTRU may reset the RLF counters and/or may stop one or more (or, e.g., any) running RLF timers for the SpCell. In an example, upon the reception of a L1/2 mobility set indication that promotes an SCell (e.g., cell b) to become the SpCell (e.g., where current SpCell may be cell a), the WTRU may determine the SCell state of cell a (e.g., based on signal level, pre-configured behaviour, based on indication received in the L1/L2 indication, and/or the like). In an example, upon the reception of a L1/L2 mobility set indication that promotes an SCell (e.g., cell b) to become the SpCell (e.g., where current SpCell may be cell a), the WTRU may send an indication to the network indicating the successful completion of the L1/L2 mobility and/or including additional information (such as, for example, the chosen SCell state of the old SpCell, measurement results of serving/candidate cells, and/or the like). In addition, a non-serving cell may become the new PCell and/or SpCell.

In an embodiment, the WTRU may receive an RRC reconfiguration that contains a L1/L2 mobility candidate cell list configuration, and/or contains cells other than the current SpCell and the Scells. In an example, the configuration may contain an SpCell configuration and/or an SCell configuration, which may be associated with one or more, or each candidate cell. The WTRU may perform one or more of the following actions. In an example, upon the reception of a L1/L2 mobility set indication that involves a candidate cell, the WTRU may apply the SCell configuration associated with the candidate cell if it is indicated that the candidate cell may become an SCell. In an example, upon the reception of a L1/L2 mobility set indication that involves a candidate cell, the WTRU may apply the SpCell configuration associated with the candidate cell if it is indicated that the candidate cell may become an SpCell.

In an embodiment, the WTRU may receive an RRC reconfiguration that comprises a L1/L2 mobility candidate cell group list configuration, and comprises cells other than the current SpCell and the SCells. In an example, the configuration may comprise an SpCell configuration and/or an SCell configuration, which may be associated with one or more, or each candidate cell. In an example, upon the reception of a L1/L2 mobility set indication that involves a candidate, the WTRU may apply the cell group configuration, which comprises any associate SpCell and SCell configurations.

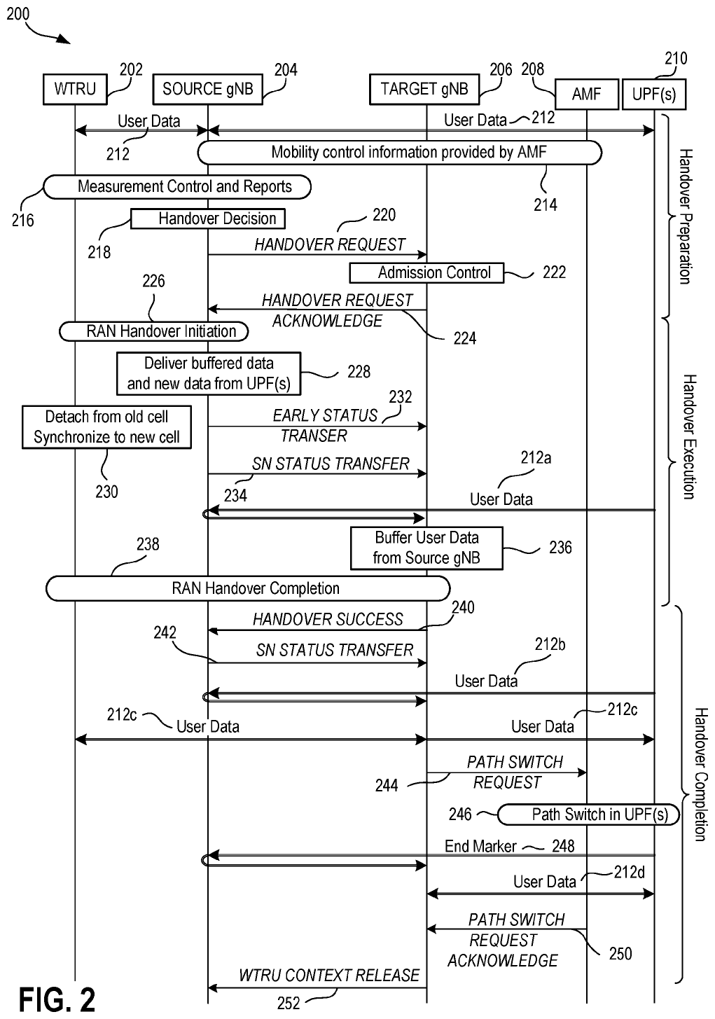

FIG. 2 is an diagram that illustrates an example of a handover procedure 200. For example, as shown in FIG. 2, at 212, a WTRU 202 may transmit data to and/or receive data from a source gNodeB (gNB) 204. The data may be transmitted to and/or received from a user plane function (UPF) 210. At 214, the Access & Mobility Management Function (AMF) may manage connection and mobility tasks for the WTRU between the source gNB 204 and target gNB 206 by providing mobility control information. The WTRU 202 context within the source gNodeB (gNB) 204 may contain information regarding roaming and/or access restrictions which may be provided (e.g., provided at connection establishment and/or at the last TA (Timing Advance) update). For example, at 216, the WTRU 202 may perform measurements and reporting. The source gNB 204 may configure the WTRU with a measurement configuration and/or the WTRU 202 may report according to the report triggering conditions indicated in the measurement configuration. At 218, the source gNB 204 may decide to handover the WTRU 202 (e.g., based on the received measurements reports). At 220, the source gNB 204 may issue a Handover Request message to the target gNB 206, which may be passing a transparent RRC container with information to prepare the handover at the target side. In an example, the information may comprise the target cell ID, the security key for the gNB (KgNB*), the cell radio network identifier (C-RNTI) of the WTRU 202 in the source gNB 204, RRM (radio source management)-configuration including WTRU inactive time, basic access stratum configuration (AS-configuration) including antenna Info and DL (Downlink) Carrier Frequency, the current quality of service (QoS) flow to data radio bearer (DRB) mapping rules applied to the WTRU, the system information block 1 (SIB1) from source gNB, the WTRU capabilities for different RATs, and packet data unit (PDU) session related information. In an example, the information may include the WTRU reported measurement information including, for example, beam-related information, if available.

At 222, admission control may be performed by the target gNB 206. For example, at 224, if the WTRU 202 is admitted, the target gNB 206 may prepare the required resources for the WTRU 202 and may send the HANDOVER REQUEST ACKNOWLEDGE to the source gNB 204, which may include a transparent container to be sent to the WTRU as an RRC message to perform the handover.

At 226, the source gNB 204 may initiate a RAN handover procedure. For example, the source gNB 204 may trigger the handover by sending an RRCReconfiguration message to the WTRU 202, which may contain the information used to access the target cell. In an example, the information used to access the target cell may include the target cell ID, the updated C-RNTI, and the target gNB 206 security algorithm identifiers for the selected security algorithms. In another example, the information used to access the target cell may include a set of dedicated RACH resources, the association between RACH resources and SSB(s), the association between RACH resources and WTRU-specific CSI-RS configuration(s), common RACH resources, and system information of the target cell, and/or the like. For one example, if dual active protocol stack (DAPS) is configured, the source connection may be kept after the handover (HO) command is sent. For another example, there may be no UL or DL communication between the WTRU and the source gNB 204 after the HO command is sent. At 228, the source gNB 204 may deliver buffered data and/or new data from UPF(s) 210 to the WTRU 202. At 230, the WTRU 202 may detach from the prior cell and synchronise to the next cell.

The source gNB 204 may transmit an early status transfer message at 232. For example, the source gNB 204 may transmit an early status transfer message when a DAPS handover is performed. At 234, the source gNB 204 may send the SN STATUS TRANSFER message to the target gNB 206 to convey the uplink PDCP (packet data convergence protocol) SN receiver status and/or the downlink PDCP SN transmitter status of DRBs for which PDCP status preservation may apply (e.g., for RLC AM). The data transmitted to the source gNB 204 at 212a may be redirected to the target gNB 206 and buffered at 236 for being sent to the WTRU 202. At 238, the WTRU 202 may perform RAN handover completion. The WTRU 202 may synchronize to the target cell and/or may complete the RRC handover procedure by sending RRCReconfigurationComplete message to target gNB 206. The target gNB 205 may transmit a handover success message to the source gNB 204 at 240. At 242, the source gNB 204 may transmit an SN status transfer message to the target gNB. The data transmitted to the source gNB 204 at 212b may be redirected to the target gNB 06 and buffered at 236 for being sent to the WTRU 202. At 212c, the WTRU 202 may transmit uplink data to and/or receive buffered data from a target gNB 206. The data may be The uplink data may be transmitted to the UPF 210. At 244, the target gNB 206 may send a PATH SWITCH REQUEST message to the AMF 208 to trigger 5GC to switch the DL data path towards the target gNB 206 and/or to establish an NG-C interface instance towards the target gNB 206. At 246, 5GC may switch the DL data path towards the target gNB 206. In an example, the UPF 210 may send one or more “end marker” packets 248 on the old path to the source gNB 204 per PDU session/tunnel and then may release any U-plane/TNL resources towards the source gNB 204. At 250, the AMF 208 may confirm the PATH SWITCH REQUEST message with the PATH SWITCH REQUEST ACKNOWLEDGE message. At 252, upon reception of the PATH SWITCH REQUEST ACKNOWLEDGE message from the AMF 208, the target gNB 206 may send the WTRU CONTEXT RELEASE to inform the source gNB 204 about the success of the handover. In an example, the source gNB 204 may then release radio and/or C-plane related resources associated to the WTRU context. In an example, any ongoing data forwarding may continue.

Message may be received by the WTRU that may contain configuration information related to L1/L2 triggered mobility (LTM). Configuration information related to LTM may be received via a medium access control element (MAC EE), a Physical Layer Downlink Control Information (PHY DCI), or one or more radio resource control (RRC) configuration/reconfiguration messages. The configuration information related to LTM may include a candidate cell group configuration. The candidate cell group configuration may include common configuration information for a serving cell and at least one candidate cell, and/or separate configuration information specific to the serving cell and each candidate cell of the at least one candidate cell. For example, the candidate cell group configuration may be applied as a master cell group (MCG) or a secondary cell group (SCG). In another example, the candidate cell group configuration may replace a preconfigured MCG configuration or a preconfigured SCG configuration.

The WTRU may perform communications with the serving cell based on the common configuration information and the configuration information specific to the serving cell. The WTRU may further receive an LTM command indication handover (HO) to a candidate cell of the at least one candidate cell. For example, the received configuration information related to LTM may be received via a medium access control element (MAC EE), a Physical Layer Downlink Control Information (PHY DCI), or one or more radio resource control (RRC) reconfigurations. The LTM command may include an existing index list. The existing index list may configure each candidate cell of the at least one candidate cell with an index value. The LTM command may include a unique index. The unique index may be assigned to a candidate cell of the at least one candidate cell.

The WTRU may further release the information specific to the serving cell. The WTRU may perform a handover to the candidate cell as a serving cell using the common configuration information and the information specific to the indicated candidate cell of the at least one candidate cell, without performing a reconfiguration of the configuration information related to LTM. For example, the handover may be performed without performing the reconfiguration of the configuration information related to LTM without performing another RRC configuration/reconfiguration via RRC configuration messages. The handover to the candidate cell as a serving cell may be, for example, based on a delta configuration. The delta configuration may include a change in at least one parameter in the configuration information related to LTM. For example, the delta configuration may include a change in one parameter in the configuration information related to LTM.

The WTRU may apply the common configuration information to the at least one candidate cell. The WTRU may further apply the separate configuration information that is specific to the indicated candidate cell of the at least one candidate cell.

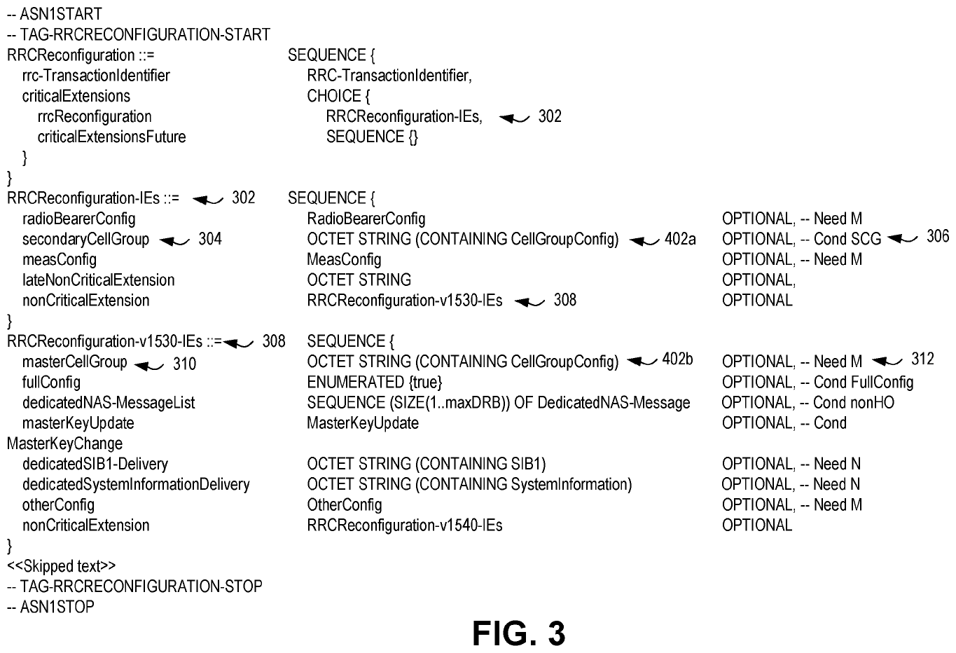

FIG. 3 is a diagram that illustrates an example of an excerpt for configuration information and information elements related to an RRCReconfiguration message. In an example, a handover (HO) command may be an RRCReconfiguration message that contains a reconfigurationWithSync. As described herein, the RRCReconfiguration message may be sent to the WTRU during handover initiation. The RRCReconfiguration message may contain the information used to access the target cell. The RRCReconfiguration message may include RRCReconfiguration information elements 302. The RRCReconfiguration information elements 302 may include a secondaryCellGroup configuration parameter 304. The secondaryCellGroup configuration parameter 304 may include a CellGroupConfig parameter 402a. The secondaryCellGroup configuration parameter 304 may be included on a condition that a SCG is configured or enabled during dual connectivity, as shown at 306.

The RRCReconfiguration information elements 302 may include additional information elements. For example, the RRCReconfiguration information elements 302 may include RRCReconfiguration information elements 308. The RRCReconfiguration information elements 308 may include a masterCellGroup configuration parameter 310. The masterCellGroup configuration parameter 310 may include a CellGroupConfig parameter 402b. The masterCellGroup configuration parameter 310 may be included in each RRCReconfiguration message that includes a MCG, as indicated at.

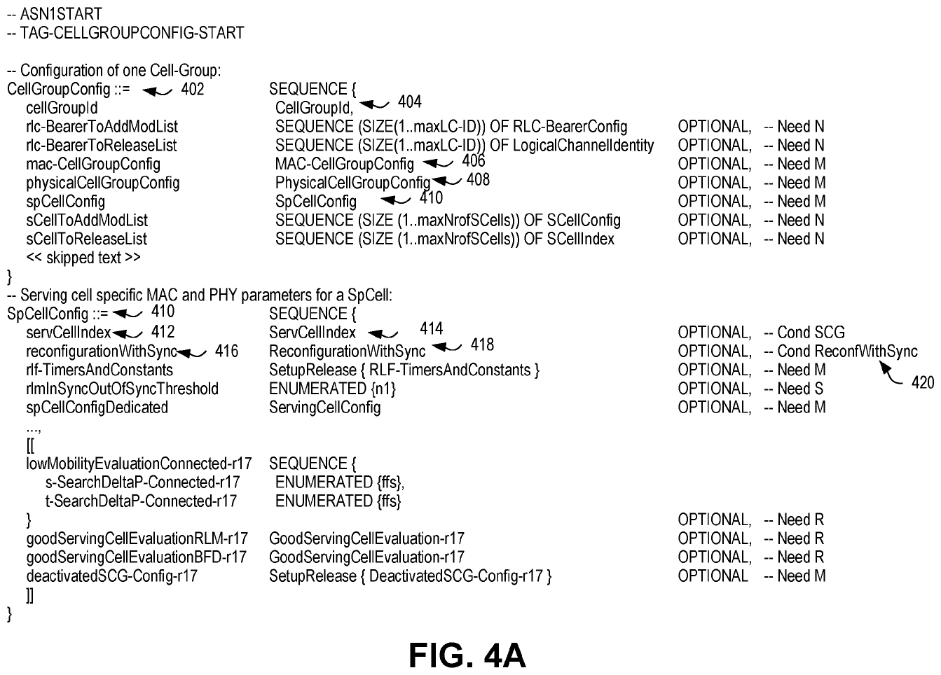

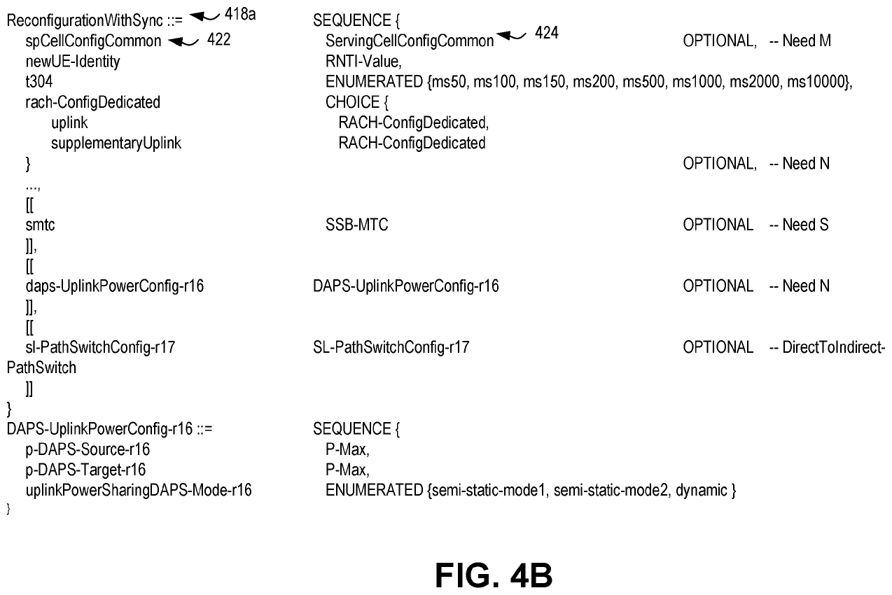

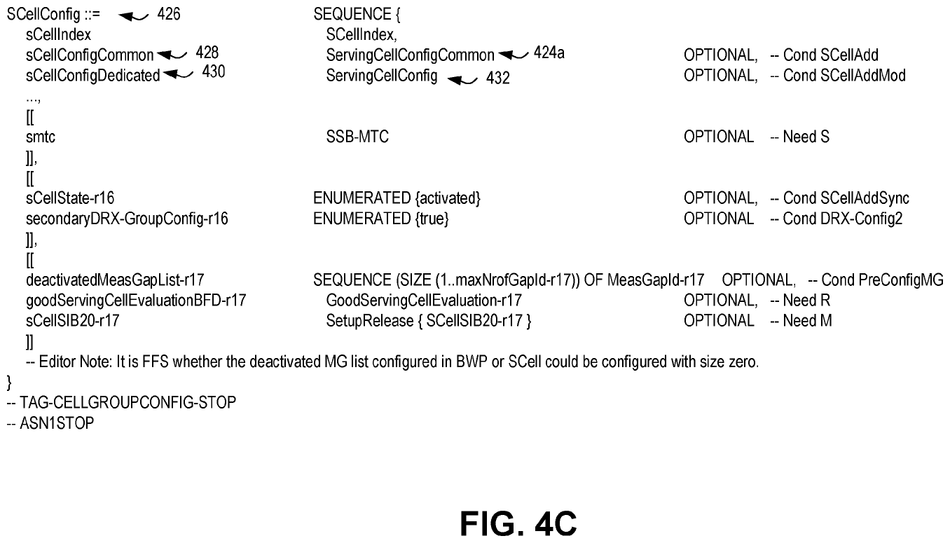

FIGS. 4A-4C are diagrams that illustrate examples of additional excerpts for configuration information and information elements related to the RRCReconfiguration message. FIGS. 4B and 4C are continued portions of the example excerpt shown in FIG. 4A. As shown in FIG. 3, the RRCReconfiguration message may contain the cell group configuration or CellGroupConfig 402 (e.g., the masterCellGroup 310 CellGroupConfig 402b, and possibly the secondaryCellGroup 304 CellGroupConfig 402a, if dual connectivity, DC, is configured).

For example, the CellGroupConfig 402 may include a cellGroupId parameter 404, a MAC-CellGroupConfig parameter 406, a PhysicalCellGroupConfig parameter 408, and/or a SpCellConfig parameter 410. The MAC-CellGroupConfig may include the configuration of the parameters of the MAC layer and/or protocol for a specific cell group. For example, the specific cell group may be the MCG and/or SCG. Similarly, the PhysicalCellGroupConfig may include the configuration of the parameters of the MAC layer and/or protocol for a specific cell group. The SpCellConfig 410 may include a servCellIndex parameter 412 and/or a reconfigurationWithSync parameter 416. The servCellIndex parameter 412 may include a ServCellIndex parameter 414. The reconfigurationWithSync parameter 416 may include a ReconfigurationWithSync parameter 418. The reconfigurationWithSync parameter 416 may be included on a condition that a ReconfWithSync is configured or enabled during dual connectivity, as shown at 420.

The ReconfigurationWithSync parameter 418a may include a spCellConfigCommon parameter 422. The spCellConfigCommon parameter 422 may include a ServingCellConfigCommon parameter 424. A SCellConfig 426 may include a sCellConfigCommon parameter 428 and/or a sCellConfigDedicated parameter 430. The sCellConfigCommon parameter 428 may include a ServingCellConfigCommon parameter 424a. The sCellConfigDedicated parameter 430 may include a ServingCellConfig parameter 432.

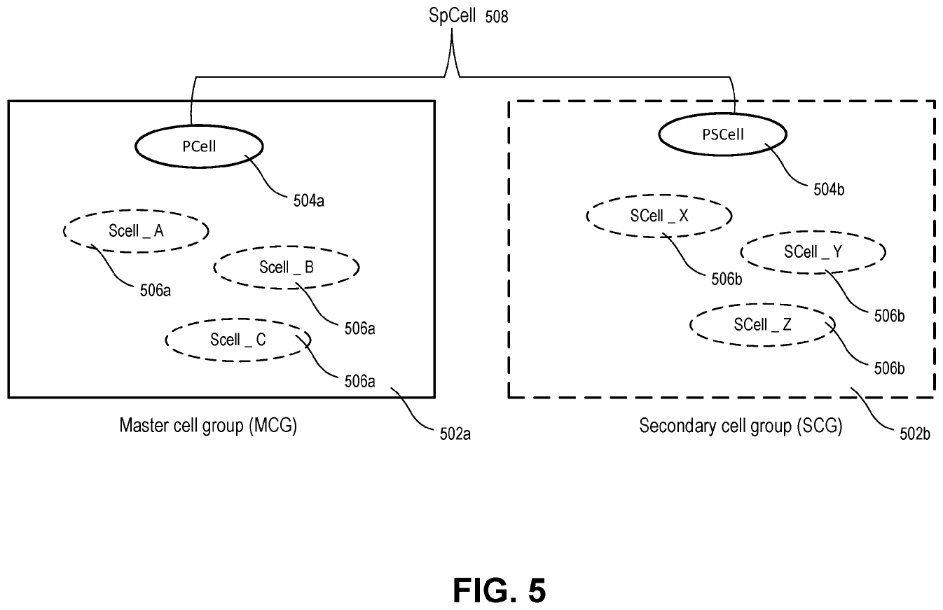

FIG. 5 is a diagram that illustrates an example of a Master Cell Group (MCG) 502a and a Secondary Cell Group (SCG) 502b. The cell group configuration may contain the configuration of each of the cells that belong to the cell group (e.g., those cells that are operating in carrier aggregation, CA). The cells, collectively known as serving cells, may be divided into the primary cell 504a, 504b and the secondary cells 506a, 506b. In an example, the primary cell 504a, 504b may be operating on the primary frequency, in which the WTRU performs the initial connection establishment procedure. In an example, the primary cell 504a, 504b may be operating on the primary frequency, in which the WTRU initiates the connection re-establishment procedure. In an example, the primary cell 504a, 504b may be operating on the primary frequency, in which the WTRU is the cell indicated as the primary cell 504a, 504b in the handover procedure. In an example, the primary cell 504a for the master cell group 502a may be referred to as PCell, while (e.g., in case DC is configured) the primary cell 504b for the secondary cell group 502b may be referred to as PSCell (Primary Secondary Cell). The term special cell (SpCell) 508 may refer the PCell 504a and/or PSCell 504b. In an example, an SCell 506a, 506b may be a cell that is providing the other carriers which are used during carrier aggregation for the corresponding cell group.

Many operations such as radio link monitoring (RLM) and associated Radio Link Failure (RLF) detection and recovery may be relevant to the primary cell. For example, the operations may be relevant to the primary cell only. Each serving cell may be identified by a servCellIndex (serving cell index), that takes a value from 0 to 31. In an example, the PCell may be assigned a servCellIndex value of 0. In another example, the PCell may be always assigned a servCellIndex value of 0.

Inter-cell L1/2 mobility may manage the beams in CA case. However, in an example, no cell change and/or add may be supported. In an embodiment, one or more mechanism and/or procedures of L1/L2 based inter-cell mobility for mobility latency reduction may be specified. For example, to specify mechanism and procedures of L1/L2 based inter-cell mobility for mobility latency reduction, configuration and/or maintenance for multiple candidate cells may be carried out to allow fast application of configurations for candidate cells (e.g., at RAN2, RAN3, and/or the like). For example, to specify mechanism and procedures of L1/L2 based inter-cell mobility for mobility latency reduction, dynamic switch mechanism among candidate cells as serving cells (e.g., including SpCell and SCell) for the potential applicable scenarios may be based on L1/L2 signalling (e.g., at RAN2, RAN1, and/or the like). For example, to specify mechanism and procedures of L1/L2 based inter-cell mobility for mobility latency reduction, L1 enhancements may be carried out for inter-cell beam management, e.g., including L1 measurement and reporting, and/or beam indication (e.g., at RAN1, RAN2, and/or the like). In an example, early RAN2 involvement may be carried out (e.g., may be necessary), which includes the possibility of further clarifying the interaction between L1 enhancements for inter-cell beam management and dynamic switch mechanism among candidate cells as serving cells. For example, to specify mechanism and procedures of L1/L2 based inter-cell mobility for mobility latency reduction, timing advance (TA) management may be carried out (e.g., at RAN1, RAN2, and/or the like).

To specify mechanism and procedures of L1/L2 based inter-cell mobility for mobility latency reduction, central unit-distributed unit (CU-DU) interface signaling may be carried out to support L1/L2 mobility if needed (e.g., at RAN3, etc.). In an example, FR2 specific enhancements may not be precluded.

The procedure of L1/L2 based inter-cell mobility may be applicable to one or more of the following scenarios: standalone, carrier aggregation (CA) and new radio dual connectivity (NR-DC) case with serving cell change within one cell group (CG); intra-DU case and intra-CU inter-DU case (e.g., applicable for Standalone and CA when no new RAN interfaces are expected); both intra-frequency and inter-frequency; both FR1 and FR2; source and target cells may be synchronized or non-synchronized; and inter-CU case may be not included.

Inter-cell beam management may address intra-DU and/or intra-frequency scenarios. In an example, the serving cell may remain unchanged (e.g., there may be no possibility to change the serving cell using L1/2 based mobility). In FR2 deployments, CA may be used to exploit the available bandwidth, for example, to aggregate multiple CCs in one band. These component carriers (CCs) may be transmitted with the same analog beam pair (gNB beam and WTRU beam). The WTRU may be configured with TCI states (e.g., may have fairly large number, e.g., 64) for reception of PDCCH and/or PDSCH. Each TCI state may include a RS or SSB that the WTRU refers to for setting its beam. The SSB may be associated with a non-serving PCI. MAC signaling (e.g., TCI state indication for WTRU-specific PDCCH MAC CE) may activate the TCI state for a Coreset/PDCCH. Reception of PDCCH from a non-serving cell may be supported by MAC CE indicating a TCI state associated to non-serving PCI. MAC signaling (e.g., TCI States Activation/Deactivation for WTRU-specific PDSCH) may activate a subset of TCI states for PDSCH reception (e.g., up to 8 TCI states for PDSCH reception). DCI may indicate the TCI states (e.g., which of the 8 TCI states). There may be a “unified TCI state” with a different updating mechanism (DCI-based), but may be without multi-TRP. There may be unified TCI state with multi-TRP.

The overall objective of L1/L2 inter-cell mobility may be to improve handover latency. With a conventional L3 handover or conditional, the WTRU may first send a measurement report using RRC signaling. In response to the measurement report, the network may provide a further measurement configuration and/or may provide a conditional handover configuration. With a conventional handover, the network may provide a configuration for a target cell after the WTRU reports using RRC signaling that the cell meets a configured radio quality criteria. With conditional handover, to reduce the handover failure rate due to the delay in sending a measurement report then receiving an RRC reconfiguration the network provides, in advance, a target cell configuration as well as a measurement criteria which determines when the WTRU may trigger the CHO configuration. Both of these L3 methods may experience some amount of delay due to the sending of measurement reports and receiving of target configurations, particularly, for example, in case of the conventional (non-conditional) handover. Particularly, for example, L1/L2 based inter-cell mobility may be aimed at allowing a fast application of configurations for candidate cells, including, for example, dynamically switching between SCells and switching of the PCell (e.g., switch the roles between SCell and PCell) without performing RRC signaling. The inter-CU case may not be included in the R18 work, as this may require relocation of the PDCP anchor and may have already been excluded from the work item. Therefore, an RRC based approach may be needed to support inter-CU handover. One of the aims of L1/L2 may be to allow CA operation to be enabled instantaneously upon serving cell change.

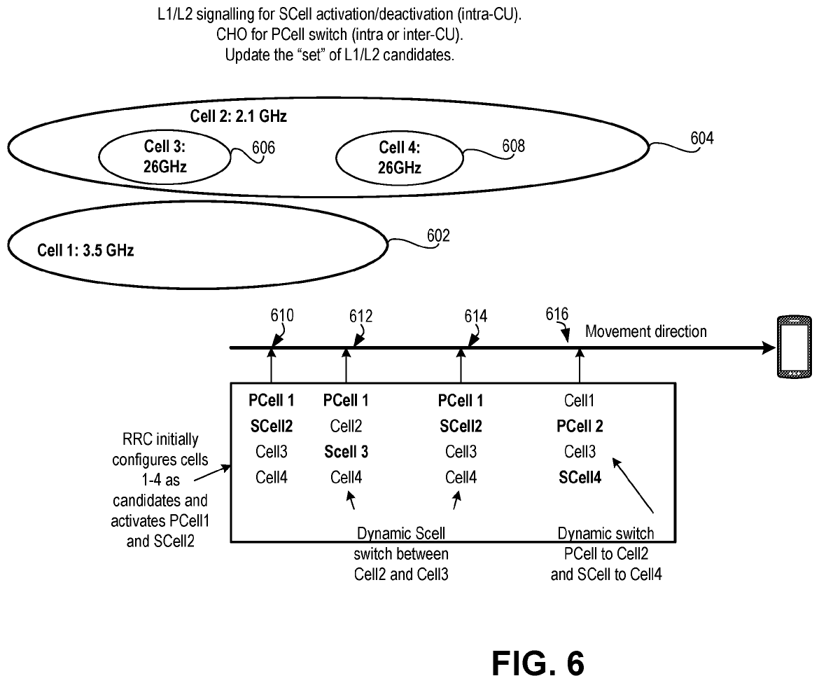

FIG. 6 is a diagram illustrating an example of L1/L2 inter-cell mobility operation. For example, the candidate cell group may be configured by RRC and a dynamic switch of PCell and SCell may be achieved using L1/L2 signaling. As mentioned above, functionality may be introduced to perform HO via L1/L2 signaling within a given mobility set (e.g., within a subset of the cells of a given gNB), where an SCell may become the new PCell. As shown in the structure of the RRC reconfiguration message and related structures discussed previously, the SpCell (e.g., the PCell or the PSCell) may require a separate configuration as compared to the SCells, as there may be several functionalities and WTRU behaviors that may be relevant (e.g., only) for the SpCell. L1/L2 switching of an SCell to a PCell may not be possible with the current RRC signalling structure, as the configuration of only one sPCell per cell group may be allowed.

The L1/L2 mobility signaling may contain an indication regarding which SCell may be promoted to a PCell. However, the solutions and associated configuration/signaling may also be applicable to the case where a non-serving neighbor cell may be promoted as a PCell. For example, in the description below, unless otherwise specified, the previous PCell may be assumed to be demoted to become an SCell upon the reception of a L1/L2 mobility signalling that promotes an SCell to a PCell. In an example, in the descriptions below, a L1/L2 signalling may refer to a MAC CE or a DCI. An SpCell configuration may be used for SCells. In an example, for each SCell, a WTRU may be configured with an associated sPCellConfig. The WTRU may store this configuration without applying it.

For example, in step 610, the RRC may initially configure cells 602, 604, 606 and 608 as candidate cells. The RRC may also initially activate cell 602 as PCell and activate cell 604 as SCell. In step 612 and step 614, a dynamic switch of the SCell between cell 604 and cell 606 may be initiated (e.g., via L1/L2 signaling). For example, in step 612, SCell may be the cell 606. For another example, in step 614, SCell may be the cell 604. In step 616, the L1/L2 signaling may dynamically switch PCell to cell 604 and SCell to cell 608 to finish the L1/L2 inter-cell mobility operation.

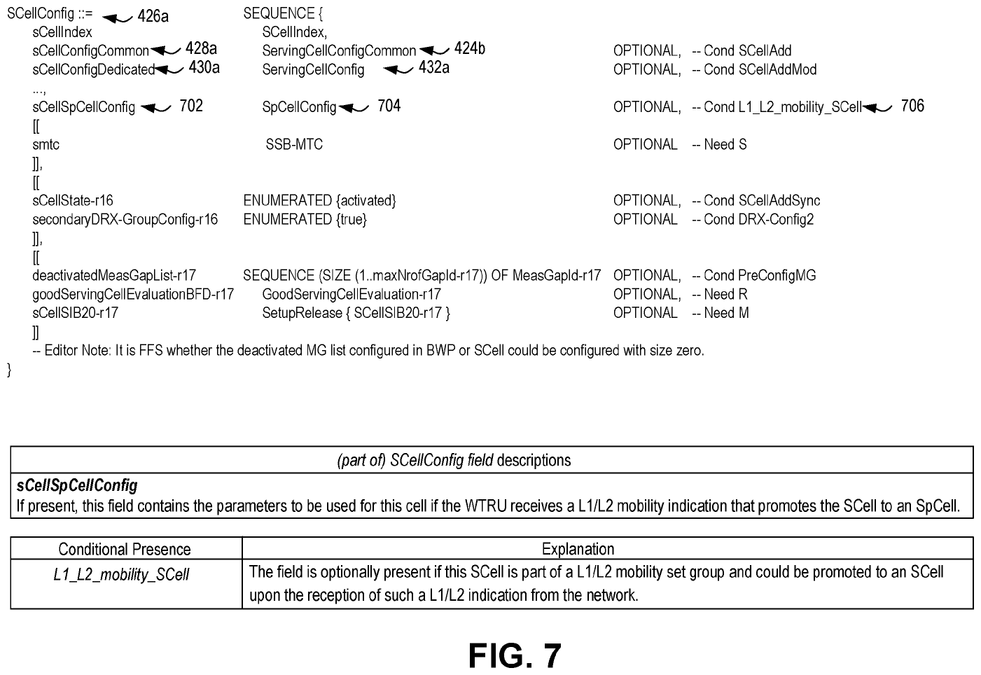

FIG. 7 is a diagram that illustrates an example ASN.1 code for capturing an example L1/L2 mobility signaling. In an example, a WTRU may be configured with an SCellConfig that is associated with an SpCell (e.g., for each cell group). The WTRU may store this configuration but may not apply it until the WTRU receives a L1/L2 message, for example, indicating that the corresponding SpCell may now be demoted to become an SCell.

The SCellConfig 426a may include a sCellConfigCommon parameter 428a, a sCellConfigDedicated parameter 430a, and/or a sCellSpCellConfig parameter 702. The sCellConfigCommon parameter 428a may include a ServingCellConfigCommon parameter 424b. The sCellConfigDedicated parameter 430a may include a ServingCellConfig parameter 432a. The sCellSpCellConfig parameter 702 may include a SpCellConfig parameter 704. The sCellSpCellConfig parameter 702 may be included on a condition that a L1_L2_mobility_SCell is configured or enabled during dual connectivity, as shown at 706. If the sCellSpCellConfig parameter 702 is present, it may contain the parameters to be used for this SCell if the WTRU receives a L1/L2 mobility indication that promotes this SCell to an SpCell. The L1_L2_mobility_SCell may be optionally present if this SCell is part of a L1/L2 mobility set group and could be promoted to an SCell upon the reception of such a L1/L2 indication from the network.

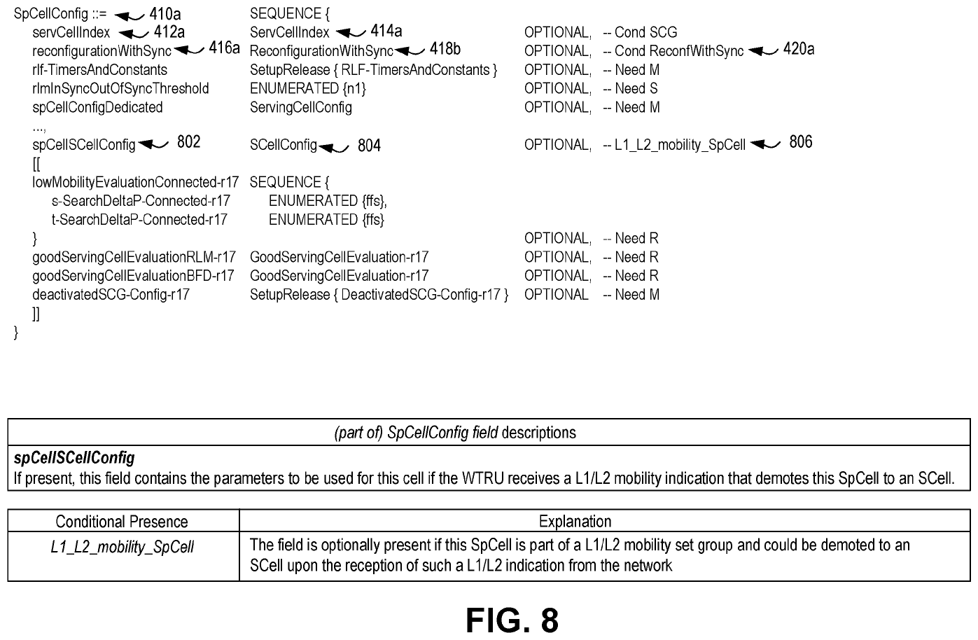

FIG. 8 is a diagram that illustrates an example of a WTRU storing a configuration until it receives a L1/L2 message. In an example, an IE (e.g., spCellSCellConfig) may be added to the SpCellConfig IE.

The SpCellConfig 410a may include a servCellIndex parameter 412a, a reconfigurationWithSync parameter 416a, and/or a spCellSCellConfig parameter 802. The servCellIndex parameter 412a may include a ServCellIndex parameter 414a. The reconfigurationWithSync parameter 416a may include a ReconfigurationWithSync parameter 418b. The reconfigurationWithSync parameter 416a may be included on a condition that a ReconfWithSync is configured or enabled during dual connectivity, as shown at 420a. The spCellSCellConfig parameter 802 may include a SCellConfig parameter 804. The spCellSCellConfig parameter 802 may be included on a condition that a L1_L2_mobility_SpCell is configured or enabled during dual connectivity, as shown at 806. If the spCellSCellConfig parameter 802 is present, this field may contain the parameters to be used for this SpCell if the WTRU receives a L1/L2 mobility indication that demotes this SpCell to an SCell. The L1_L2_mobility_SpCell may be optionally present if this SpCell is part of a L1/L2 mobility set group and could be demoted to an SCell upon the reception of such a L1/L2 indication from the network.

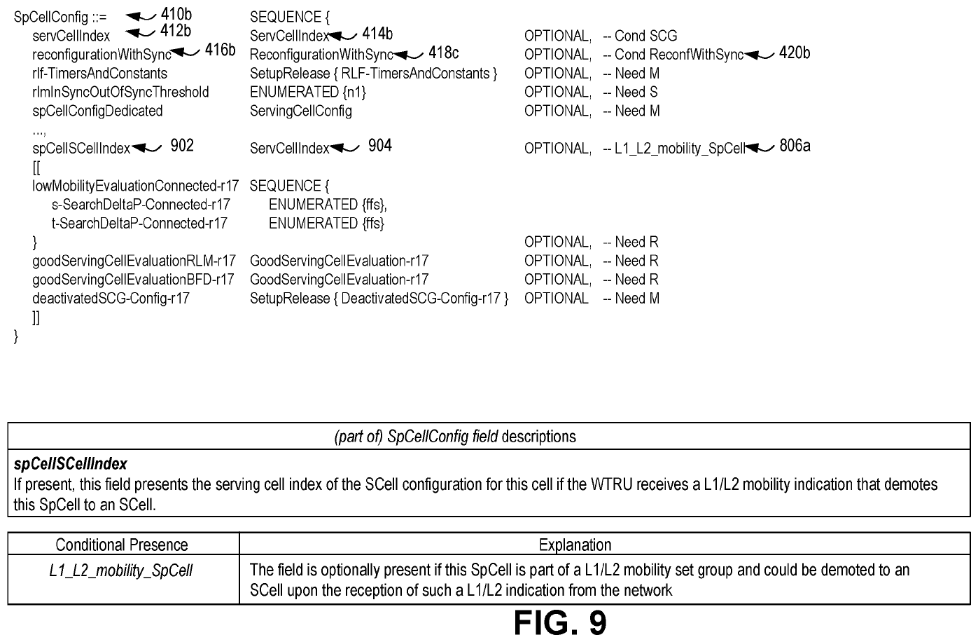

FIG. 9 is a diagram that illustrates an example of a WTRU storing a configuration until it receives a L1/L2 message. In an example, an additional SCell may be added using the sCellToAddModList IE of the CellGroupConfig, and the serving cell index of this SCell may be associated with the SpCell. In an example, the WTRU may be configured with a list of candidate cells, and each may be provided with one or more of the following: CandidateCellIndex (and/or servingCellIndex); SpCellConfig; SCellConfig; and/or OtherConfig.

The SpCellConfig 410b may include a servCellIndex parameter 412b, a reconfigurationWithSync parameter 416b, and/or a spCellSCellIndex parameter 902. The servCellIndex parameter 412b may include a ServCellIndex parameter 414b. The reconfigurationWithSync parameter 416b may include a ReconfigurationWithSync parameter 418c. The reconfigurationWithSync parameter 416b may be included on a condition that a ReconfWithSync is configured or enabled during dual connectivity, as shown at 420b. The spCellSCellIndex parameter 902 may include a ServCellIndex parameter 904. The spCellSCellIndex parameter 902 may be included on a condition that a L1_L2_mobility_SpCell is configured or enabled during dual connectivity, as shown at 806a. If the spCellSCellindex parameter 902 is present, this field may contain the parameters to be used for this SpCell if the WTRU receives a L1/L2 mobility indication that demotes this SpCell to an SCell. The L1_L2_mobility_SpCell may be optionally present if this SpCell is part of a L1/L2 mobility set group and could be demoted to an SCell upon the reception of such a L1/L2 indication from the network

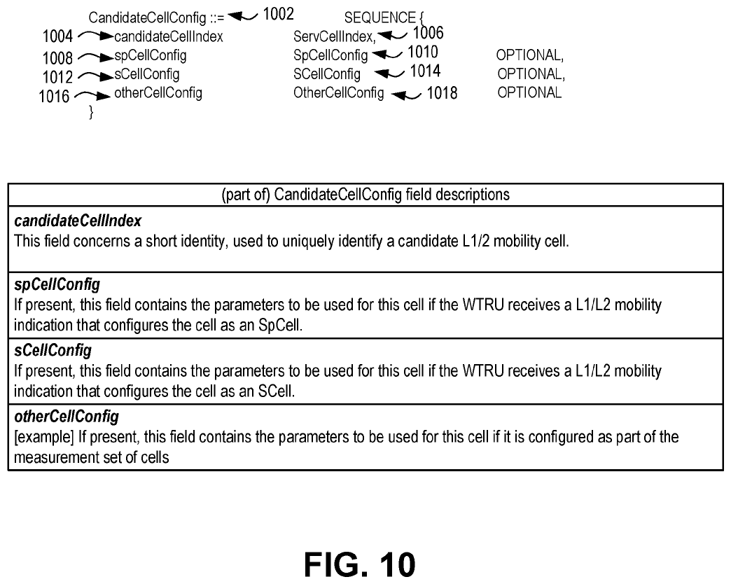

FIG. 10 is a diagram illustrating an example ASN.1 structure. A CandidateCellConfig 1002 may include a candidateCellIndex parameter 1004, a spCellConfig parameter 1008, a sCellConfig parameter 1012, and/or an otherCellConfig parameter 1016. The candidateCellIndex parameter 1004 may include a ServCellIndex parameter 1006. The spCellConfig parameter 1008 may include a SpCellConfig parameter 1010. The sCellConfig parameter 1012 may include a SCellConfig parameter 1014. The otherCellConfig parameter 1016 may include an OtherCellConfig parameter 1018. The candidateCellIndex parameter 1004 may concern a short identity and may be used to uniquely identify a candidate L1/L2 mobility cell. If the spCellConfig parameter 1008 is present, it may contain the parameters to be used for this cell if the WTRU receive a L1/L2 mobility indication that configures this cell as an SpCell. If the sCellConfig parameter 1012 is present, it may contain the parameters to be used for this cell if the WTRU receives a L1/L2 mobility indication that configures this cell as an SCell. If the otherCellConfig parameter 1016 is present, it may contain the parameters to be used for this cell if this cell is configured as part of the measurement set of cells.

Each candidate cell may be provided with one or more potential configurations. A cell may be configured with an SpCellConfig if the cell may at some point in the future be configured as an SpCell. A cell may be configured with an SCellConfig if the cell may at some point in the future be configured as an SCell. An additional configuration (e.g., OtherCellConfig) may contain parameters to be used under certain circumstances. For example, it may be possible to configure more cells than just SpCells for the WTRU to perform RLM measurements on, In an example, these cells may be SCells or they may be candidate cells (e.g. potential SCells but not currently configured as such). These cells using “other” config may have an intermediate state, for example, cells which are monitored in terms of any of, or one or more of: RLM, beam tracking, BFD, PDDCH monitoring, timing advance maintenance, before becoming active PCells and/or SCells. These cells may be configured to use the “other” config by the L1/L2 mobility command. A unique index (e.g. candidateCellIndex) may be assigned to each configured candidate cell (the candidate cell associated with multiple configurations as described above). This index may be referred to by the L1/L2 mobility command (e.g. a MAC CE or DCI) when setting the state of the cell or switch it to an SpCell (from an SCell) or vice versa. Alternatively, or in conjunction, each cell may be configured with an index value using the existing servCellIndex and/or sCellIndex (e.g., contained within SpCellConfig and SCellConfig), which may be referred to by the L1/L2 mobility command.

Upon receiving an L1/L2 mobility command, which informs the WTRU which cells are SpCells, which cells are SCells, and potentially which cells are included in the “other” cells group, the WTRU may reassign servCellIndex and/or sCellIndex according to the arrangement, for example, in order that existing L1, MAC, and/or RRC procedures may refer to these indexes. For example, a PCell may be assigned servCellIndex 0 and SCells may be assigned servCellIndex and sCellIndex 1 . . . N, for example in order of their candidateCellIndex. The WTRU may apply the relevant configuration according to the L1/L2 command assignment For example, the WTRU may release the current SpCellConfigs and SCell configs and may apply the new configuration. The WTRU may, alternatively or in conjunction, modify the existing configuration according to the new assignment. For example, the WTRU may move the new PCell from servCellIndex N to servCellIndex 0, and move SCells which have been indicated in the L1/L2 mobility command to servCellIndex 1 . . . N.

The WTRU may be configured with a list of candidate cell groups. Each of the candidate cell groups may include one or more of: a candidateCellGroupIndex; a cellGroupId, SpCellConfig (e.g. one or more potential SpCells); SCellConfig (e.g. list of SCells); OtherConfig; rlc-BearerToAddModList (e.g., list of RLC-BearerConfig); rlc-BearerToReleaseList (e.g., list of LogicalChannelIdentity); MAC-CellGroupConfig; and/or PhysicalCellGroupConfig. In an example, the WTRU may be configured with one candidate cell group configuration per candidate SpCell, which contains a list of potential SCells. Upon receiving the L1/L2 mobility indication, the WTRU may apply the cell group configuration and/or apply the SpCell configuration. The WTRU may receive, for example, in the same L1/L2 mobility indication (e.g., SpCell and SCells may be indicated in the same MAC CE) and/or in a separate indication (e.g., in a separate MAC CE), which of the one or more listed SCells to configure. The WTRU may reassign the serving cell identities as described previously. The WTRU may move the PCell to identity 0 and any configured SCells, for example, from index 1 up to 31.

In one example, the WTRU may be configured with one candidate cell group configuration per SpCell and/or SCell combination. For example, if the SpCell is Cell A or Cell B, and the SCell is Cell A, and/or Cell B, and/or Cell C, then the WTRU may be configured with 6 cell group configurations as follows: (1) the SpCell may be Cell A, and the SCell may be Cell B; (2) the SpCell may be Cell A, and the SCell may be Cell C; (3) the SpCell may be Cell A, and the SCell may be Cell B and/or Cell C; (4) the SpCell may be Cell B, and the SCell may be Cell A; (5) the SpCell may be Cell B, and the SCell may be Cell C; and/or (6) the SpCell may be Cell B, and the SCell may be Cell A and/or Cell C.

The L1/L2 mobility indication may contain a pointer to the candidate cell group configuration which, upon reception, the WTRU may apply the associated cell group configuration, for example, replacing (e.g., releasing) any previously configured serving cells and/or configuring (e.g., adding) the new serving cells, and/or assigning them the preconfigured explicit serving cell identities.

In an example, the WTRU may be configured with one Cell group configuration which may be associated with one or more potential SpCells and/or one or more potential SCells. The L1/L2 mobility indication may contain a pointer to the candidate cell group configuration, the candidate cell to configure as SpCell, and/or the candidate cells to configure as SCells. In an example, upon receiving the L1/L2 mobility indication, the WTRU may apply the indicated candidate cell group configuration and/or may apply the relevant candidate cell configurations using any of the methods as previously described.

In an example, each candidate cell group configuration may be preconfigured as either being a master cell group (MCG) or secondary cell group (SCG) configuration. Upon receiving the L1/L2 mobility command, the WTRU may replace the current MCG or SCG with the indicated cell group configuration, for example, depending on whether the preconfiguration is associated with MCG or SCG. In an example, the candidate cell group may not be associated with SCG or MCG. The WTRU may apply the candidate cell group configuration to MCG or SCG, for example, depending on an indication received in the L1/L2 mobility command as to whether the candidate cell group configuration may be applied as MCG or SCG.

In an example, the WTRU may be configured with a list of candidate RRC Reconfigurations, each of which may be provided with one or more of the following: radio bearer configuration; MCG configuration (e.g., CellGroupConfig); SCG configuration (e.g., CellGroupConfig); CellGroupConfig (e.g., CSG/MCG not specified); full configuration flag; measurement configuration; master key update; SIB1; and/or other configurations.

In an example, the WTRU may be configured with one candidate RRC configuration per candidate SpCell. In an example, the WTRU may be configured with one candidate RRC configuration per combination of SpCells and SCells. In an example, the WTRU may be configured with one candidate RRC reconfiguration per cell group configuration. In an example, the WTRU may be configured with one or more candidate RRC reconfigurations, one or more candidate cell group configurations, one or more candidate SpCells, and/or one or more candidate Scells. The L1/L2 mobility indication may indicate one or more of: the candidate RRC reconfigurations, the candidate cell group configurations, the candidate SpCell configurations, and the candidate SCell configurations. The WTRU may apply the indicated configurations, and/or a combination of indicated configurations according to any of the methods or examples described above.

In an example, when the WTRU receives a L1/L2 mobility signaling indication, it may perform one or more of the following: release the CellGroupConfig associated with the current cell group(s); apply the one or more CellGroupConfig indicated to be configured as the new cell group configuration; release the one or more measurement configurations associated with the current RRC configuration; apply the new one or more measurement configurations associated with the new assignment; perform a master key update; apply a full reconfiguration; store the SIB1 configuration; update the physical cell group configuration (release the current configuration and apply the new one); update the MAC cell group configuration (release the current configuration and apply the new one); release logical channels (RLC bearer configurations); add logical channels (RLC bearer configurations); update the servingCellIndex and sCellIndex of all of the current serving cells based on the new assignment, as described above; release the sPCellConfig associated with the current PCell; apply the sCellConfig associated with the current PCell; release the sCellConfig associated with the SCell indicated to be promoted to a PCell; and/or apply the sPCellConfig associated with the indicated SCell.

In an example, when the WTRU receives a L1/L2 mobility signaling indication, it may reset the counters used while performing radio link monitoring (RLM) on the SpCell. For example, N310 may be used to count the number of “out-of-sync” indications from lower layers. For another example, N311 may be used to count the number of “in-sync” indications from lower layers. In an example, when the WTRU receives a L1/L2 mobility signalling indication, it may stop any running timers that are used while performing RLM for the SpCell. For example, T310 may be started upon detecting physical layer problems for the SpCell, e.g., upon receiving N310 consecutive out-of-sync indications from lower layers. For example, T312 may be started upon triggering of a measurement report for a measurement identity for which T312 may have been configured, while T310 in the SpCell is running.

In an example, upon the reception of a L1/L2 signalling, the WTRU may keep the current SpCell as an active SCell. In an example, upon the reception of a L1/L2 signalling, the WTRU may keep the current SpCell as an SCell, but in a dormant state (e.g., associate the cell with a dormant bandwidth part). In an example, upon the reception of a L1/L2 signalling, the WTRU may keep the current SpCell as an SCell, but in a deactivated state. In an example, upon the reception of a L1/L2 signalling, the WTRU may release the cell configuration associated with the current SpCell, rather than demoting it to an SCell (e.g., applied for the previous SpCell). In an example, the L1/L2 signalling may include an indication on one of the above behaviors regarding the handling of the current SpCell (e.g., release, keep as an SCell in dormant state, keep as an SCell in deactivated state, keep as an SCell in active state, and/or the like). In an example, the WTRU may be configured, prior to the reception of the L1/L2 mobility indication (e.g., dedicated signaling via RRC/MAC, broadcast signalling, and/or the like), on which of the above behaviors regarding the handling of the current SpCell to be applied (e.g., release, keep as an SCell in dormant state, keep as an SCell in deactivated state, keep as an SCell in active state, and/or the like). In an example, the behavior regarding the current SpCell upon L1/L2 mobility may be the same for any cell in the serving cell list and/or candidate set list.

In an example, the WTRU may be configured with different behavior regarding the handling of the current SpCell, that is dependent on the (e.g., type of) the current SpCell. For example, the WTRU may be configured to keep the cell as an active SCell if the frequency of the SpCell is equivalent to a certain value and/or belongs within a certain value range but may keep the cell as a deactivated SCell if the frequency of the PCell is different from a certain value and/or doesn't belong within a given range of values. Apart from frequency, other criteria such as the bandwidth may also be used. it could also be envisioned that the behavior maybe explicitly indicated per each candidate/serving cell (e.g., as part of the SpCell configuration associated with that given cell, as part of the SCellConfig, etc.).

In an example, the determination of the SCell state (e.g., for the SpCell that has now become an SCell) may be based on the signal level of the cell. For example, two thresholds may be configured, where if the cell has signal level above the first threshold, the SCell state may be activated. For example, two thresholds may be configured, where if the cell has signal level between the first and the second threshold, the SCell state may be dormant. For example, two thresholds may be configured, where if the signal level of the cell is below the second threshold, the SCell state may be deactivated.

In an example, the WTRU may be configured with only one SpCellConfig that is initially associated with the current SpCell, but may become associated with the new SpCell when an SCell is promoted to an SpCell. For example, the WTRU may not need to re-apply the SpCellConfiguration again when another cell becomes the SpCell. In an example, some parts/IEs of the SpCellConfig may be shared by all the cells, while other parts may be associated explicitly with a given cell. For example, the dedicated serving cell configuration for the SpCell (e.g., spCellConfigDedicated IE), may be specific for each cell, while the rest of the SpCellConfig may be reused by each cell Which IEs are shared may be fixed in the 3GPP RRC specifications, and/or the network may dynamically indicate to the WTRU (e.g., implicitly or explicitly) which IEs may be shared and which may not be shared.

In the case of the example of providing a candidate cell list, the candidate cell list may contain a list of “delta” configurations (for example, the SpCell parameters that differ from the initial SpCell configuration) rather than a list of complete SpCell and/or SCell configurations. In an example, when the L1/L2 mobility signalling is received, the WTRU may keep the configuration/IEs of the SpCell that may be shared by all the cells but may apply the IEs that may be explicitly associated with the SCell that is being promoted to become the SpCell.

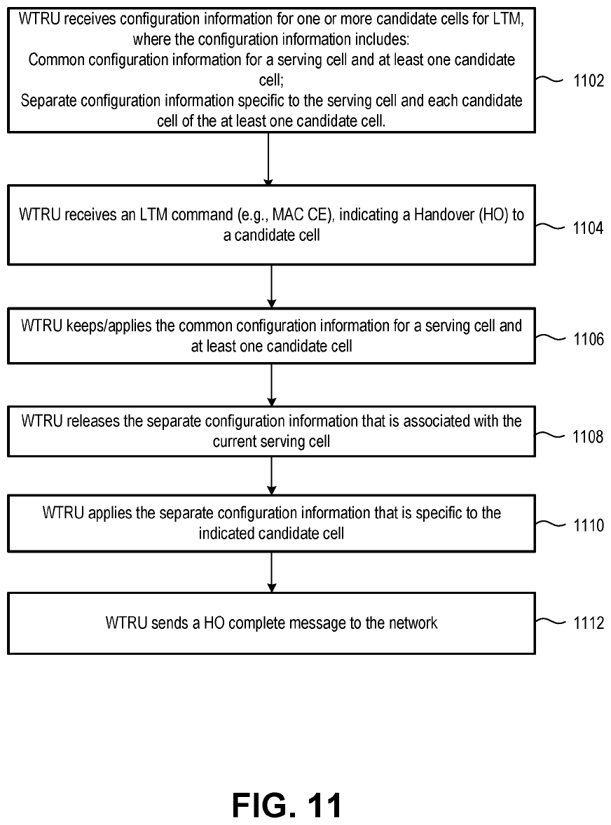

FIG. 11 is a flow chart illustrating a method for the WTRU to perform L1/L2 switching of primary cells (PCells) in a way that may not require RRC reconfiguration for subsequent PCell change. The method may include, for example, releasing the cell specific information for the source cell while maintaining the common information during handover. In other words, for example, the WTRU may perform L1/L2 switching of PCells without performing a new, subsequent cell group configuration. In 1102, the WTRU may receive configuration information for one or more candidate cells for LTM. The configuration information may include configuration common to multiple cells (e.g., serving cell and candidate cells), and/or configuration that is specific to each candidate cell. In 1104, the WTRU may receive an LTM command indicating a handover (HO) to a candidate cell. The LTM command may include, for example, a medium access control element (MAC EE) or a Physical Layer Downlink Control Information (PHY DCI). In 1106, the WTRU may keep and/or apply the configuration that is shared by the multiple cells. In 1108, the WTRU may release the configuration that associated with the current serving cell. In 1110, the WTRU may apply the configuration that is specific to the indicated candidate cell. In 1112, the WTRU may send a HO complete message to the network. In this approach, the WTRU may receive 1 configuration information, which includes configuration common to multiple cells and/or configuration specific to each candidate cell. The WTRU may perform L1/L2 switching of primary cells with minimal signaling requirement and without RRC configuration in between. In other words, the WTRU may perform L1/L2 switching of primary cells without sending and receiving the full WTRU configuration information. The WTRU may perform one or more L1/L2 switching of primary cells. In this approach, the WTRU may receive an additional LTM command, but may not receive additional RRC configuration. For example, the WTRU may receive a second handover LTM command indicates HO to previous candidate cell without additional reconfiguration.

1. A method performed by a wireless transmit/receive unit (WTRU), the method comprising:
receiving a candidate cell group configuration that is common to a group of candidate cells and at least one candidate radio resource control (RRC) configuration that is each associated with at least one candidate cell of the group of candidate cells;
receiving an L1/L2 mobility indication indicating a cell switch to a target cell of the group of candidate cells;
replacing a current WTRU RRC configuration with the cell group configuration; and
applying a candidate RRC configuration of the at least one candidate RRC configuration associated with the target cell in addition to the cell group configuration for performing the cell switch.

2.-5. (canceled)

6. The method of claim 1, wherein the candidate cell group configuration is applied as a master cell group (MCG) or a secondary cell group (SCG).

7. The method of claim 1, wherein the current WTRU RRC configuration comprises a preconfigured MCG configuration or a preconfigured SCG configuration.

8.-10. (canceled)

11. A wireless transmit/receive unit (WTRU) comprising:
a transceiver; and
a processor configured to:
receive a candidate cell group configuration that is common to a group of candidate cells and at least one candidate radio resource control (RRC) configuration that is each associated with at least one candidate cell of the group of candidate cells;
receive an L1/L2 mobility indication indicating a cell switch to a target cell of the group of candidate cells;
replace a current WTRU RRC configuration with the cell group configuration; and
apply a candidate RRC configuration of the at least one candidate RRC configuration associated with the target cell in addition to the cell group configuration for performing the cell switch.

12.-15. (canceled)

16. The WTRU of claim 11, wherein the candidate cell group configuration is applied as a master cell group (MCG) or a secondary cell group (SCG).

17. The WTRU of claim 11, wherein the current WTRU RRC configuration comprises a preconfigured MCG configuration or a preconfigured SCG configuration.

18.-20. (canceled)

21. The method of claim 1, wherein the method further comprising:
receiving a second L1/L2 mobility indication indicating a second cell switch to a second target cell of the group of candidate cells;
replacing the candidate RRC configuration associated with the target cell with a second candidate RRC configuration associated with the second target cell; and
applying the cell group configuration and the second candidate RRC configuration associated with the second target cell.

22. The method of claim 1, wherein only one candidate RRC configuration associated with one candidate cell is received.

23. The method of claim 1, wherein the at least one candidate RRC configuration comprises a candidate cell list, wherein the candidate cell list comprises a list of delta configurations related to an initial target cell configuration.

24. The method of claim 1, wherein the L1/L2 mobility indication comprises a media access control control element (MAC CE).

25. The method of claim 24, wherein the L1/L2 mobility indication comprises a pointer to the target cell.

26. The method of claim 24, wherein the L1/L2 mobility indication comprises one or more candidate RRC reconfigurations.

27. The method of claim 1, further comprising sending an RRC complete message to the target cell.

28. The WTRU of claim 11, wherein the processor is further configured to:
receive a second L1/L2 mobility indication indicating a second cell switch to a second target cell of the group of candidate cells;
replace the candidate RRC configuration associated with the target cell with a second candidate RRC configuration associated with the second target cell; and
apply the cell group configuration and the second candidate RRC configuration associated with the second target cell.

29. The WTRU of claim 11, wherein only one candidate RRC configuration associated with one candidate cell is received.

30. The WTRU of claim 11, wherein the at least one candidate RRC configuration comprises a candidate cell list, wherein the candidate cell list comprises a list of delta configurations related to an initial target cell configuration.

31. The WTRU of claim 11, wherein the L1/L2 mobility indication comprises a media access control control element (MAC CE).

32. The WTRU of claim 31, wherein the L1/L2 mobility indication comprises a pointer to the target cell.

33. The WTRU of claim 31, wherein the L1/L2 mobility indication comprises one or more candidate RRC reconfigurations.

34. The WTRU of claim 11, wherein the processor is further configured to send an RRC complete message to the target cell.
